(19) United States
(12) Patent Application Publication
(10) Pub. No.: US 2026/0336225 A1
(43) Pub. Date: Oct. 29, 2026

(54) SELF-ADAPTIVE THREE-DIMENSIONAL (3D) PRINTING METHOD FOR GEOLOGICAL BODY MODEL IN COLD REGION

(71) Applicant: Tongji University, Shanghai (CN)

(72) Inventors: Jie ZHOU, Shanghai (CN); Chengjun LIU, Shanghai (CN); Chao BAN, Shanghai (CN); Huade ZHOU, Shanghai (CN); Xin WANG, Shanghai (CN); Zhenming SHI, Shanghai (CN); Kangdi MU, Shanghai (CN); Xiangzhen KONG, Shanghai (CN)

(21) Appl. No.: 19/549,270

(22) Filed: Feb. 25, 2026

(30) Foreign Application Priority Data
Apr. 25, 2025 (CN) 202510525776.3

(51) Int. Cl. B29C 64/393; B29K 67/00; B33Y 50/02

(52) U.S. Cl. CPC B29C 64/393; B33Y 50/02; B29K 2067/046

(57) ABSTRACT

This application provides a self-adaptive three-dimensional (3D) printing method for a geological body model in cold region, including: establishing a geological body model in a cold region; analyzing the structure of the geological body model with thermo-mechanical coupling simulation, and determining whether an overall structural stability is feasible; further outputting stress and strain distribution cloud map of material shrinkage through the thermo-mechanical coupling simulation, identifying microcrack ranges with image processing method, and delineating high-risk regions of interlayer delamination; generating a 3D printing model according to the geological body model with feasible structural stability and positional information of delineated high-risk regions; optimizing printing parameters; performing 3D printing according to the generated 3D printing model and optimized printing parameters, performing 3D printing, fine-adjusting and correcting layer thickness and printing speed during 3D printing with an online laser scanner, thereby realizing high-precision 3D printing of the geological body model in cold region.

### CROSS REFERENCE TO RELATED APPLICATION

This patent application claims the benefit and priority of Chinese Patent Application No. 2025105257763, filed with the China National Intellectual Property Administration on Apr. 25, 2025, the disclosure of which is incorporated by reference herein in its entirety as part of the present application.

### TECHNICAL FIELD

The present disclosure relates to the technical field of alpine geotechnical engineering, and in particular to a self-adaptive three-dimensional (3D) printing method for a geological body model in a cold region.

### BACKGROUND

Cold regions have complex geological processes and frequent geological hazards, which is detrimental to construction and socio-economic development of China's alpine regions. Establishing geological body model in the cold regions in laboratories and conducting various controllable disaster evolution tests can avoid impacts of complex natural factors. This method offers higher feasibility and scientificity, but requires the construction of high-precision geological body model. 3D printing is a manufacturing technology that constructs objects layer by layer. It can rapidly construct models with complex 3D morphological structures, and can be used to construct 3D models that are highly consistent with actual geological bodies, thereby facilitating cross-scale scientific research on geological hazards in the cold regions.

However, due to such factors as low temperatures and changes in material properties in the cold regions, the precision and stability of the 3D printing are often compromised. In the cold regions, the printing materials of the geological body model undergo significant shrinkage and deformation during cooling. This uncontrollable factor renders the printing precision difficult to guarantee. In the cold regions, the materials of the geological body model cannot be uniformly distributed and fully solidified during printing due to their poor fluidity and high viscosity, which impairs the interlayer bonding strength, thereby compromising quality and performance of the models.

### SUMMARY

An objective of the present disclosure is to provide a 3D printing method for manufacturing a high-precision geological body model for a model test in a cold region.

To achieve the above objective, the present disclosure provides a self-adaptive 3D printing method for a geological body model in a cold region, including following steps:
S1: establishing a geological body model in a cold region, including a structure and material parameters of the geological body model;
S2: analyzing the structure of the geological body model with thermo-mechanical coupling simulation, and calculating an overall structural stability to determine whether the structure is feasible;
S3: for a feasible geological body model, outputting a stress distribution cloud map and a strain distribution cloud map on material shrinkage in the cold region through the thermo-mechanical coupling simulation, identifying a microcrack range with an image processing method, and delineating a high-risk region of interlayer delamination;
S4: according to the feasible geological body model and positional information of the high-risk region, generating a 3D printing model, and optimizing printing parameters;
S5: performing 3D printing according to a generated 3D printing model and optimized printing parameters, where during the 3D printing, dynamic adjustment of a layer thickness and a printing speed, real-time detection and correction of a model morphology, and self-adaptive precompensation of the printing parameters are performed simultaneously; and
S6: by self-adaptively controlling the printing parameters, monitoring an effect of the generated 3D printing model in real time and correcting the generated 3D printing model in real time, and completing high-precision 3D printing of the geological body model in the cold region.

Further, the printing parameters include the layer thickness, an infill density, the printing speed, and a temperature.

In the step S2, the thermo-mechanical coupling simulation has two functions: A first function is to calculate whether the structure is reasonable. For example, if the structure is a slope, whether the slope is stable is calculated to ensure that the structure does not collapse. A second function is to delineate the high-risk region of the interlayer delamination. While the structure is reasonable, positional information prone to the interlayer delamination during the 3D printing is calculated.

In the step S3, while the structure is feasible, the stress distribution cloud map and the strain distribution cloud map on the material shrinkage in the cold region are further output through the thermo-mechanical coupling simulation, the microcrack range is identified with the image processing method, and the high-risk region of the interlayer delamination is delineated, facilitating optimization on the layer thickness. Specifically, a transient heat transfer model is constructed through the thermo-mechanical coupling simulation, a melting-solidification process of a printing material during the 3D printing is simulated, the stress distribution cloud map and the strain distribution cloud map on the material shrinkage are obtained, the microcrack range is identified with the image processing method, and the high-risk region of the interlayer delamination is delineated.

Further, in the step S5, during the 3D printing, according to real-time feedback on an environment temperature in a model chamber during the 3D printing and on a nozzle temperature during the 3D printing, the layer thickness and the printing speed are dynamically adjusted, so as to prevent the interlayer delamination to ensure a printing precision; and a principle for dynamically adjusting the layer thickness is to decrease the layer thickness when the environment temperature or the nozzle temperature is less than a design temperature, and increase the layer thickness when the environment temperature or the nozzle temperature is greater than the design temperature.

Further, in the step S5, during the 3D printing, a surface morphology is scanned with an online laser scanner, and is compared with a model design scheme in real time; and if a local dimensional deviation exceeds a control precision, additional printing or trimming is performed, thereby realizing the real-time detection and correction of the model morphology.

Further, in the step S5, by fusing temperature and model morphology error monitoring data, a printing error of a next layer is predicted and compensated in advance, thereby realizing the self-adaptive precompensation of the printing parameters.

Compared with the prior art, the present disclosure has the following advantages:
1. The present disclosure verifies the printing adaptability of the model structure with the cold region through a simulation technology, optimizes and verifies the corresponding printing parameters according to the printing material of the geological body, self-adaptively controls the printing parameters in the cold region from the input parameter and the model effect according to online temperature measurement data and morphology scanning data during the printing, monitors the model effect in real time, and corrects the model in real time, thereby realizing the high-precision 3D printing of the geological body model in the cold region. The printing model exhibits strong stability and high precision, which solves the problems of poor stability and low precision of the 3D printing due to the low temperature or the changes in material properties in the cold region in the conventional art.
2. The present disclosure calculates the overall stability of the model structure in the cold region through the thermo-mechanical coupling simulation, preventing material waste caused by inadaptability of the model structure with the cold region.
3. The present disclosure provides different layer thicknesses, different printing speeds, and other printing parameters according to sensitivities of different portions of the printing material of the geological body model in the cold region to cracks, enhancing the printing precision, and improving the printing effect.

### BRIEF DESCRIPTION OF THE DRAWINGS

FIG. 1 is a schematic flowchart of a self-adaptive 3D printing method for a geological body model in a cold region according to an embodiment of the present disclosure.

### DETAILED DESCRIPTION OF THE EMBODIMENTS

To make the objectives, technical solutions, and advantages of the present disclosure clearer, the following further describes the technical solutions of the present disclosure.

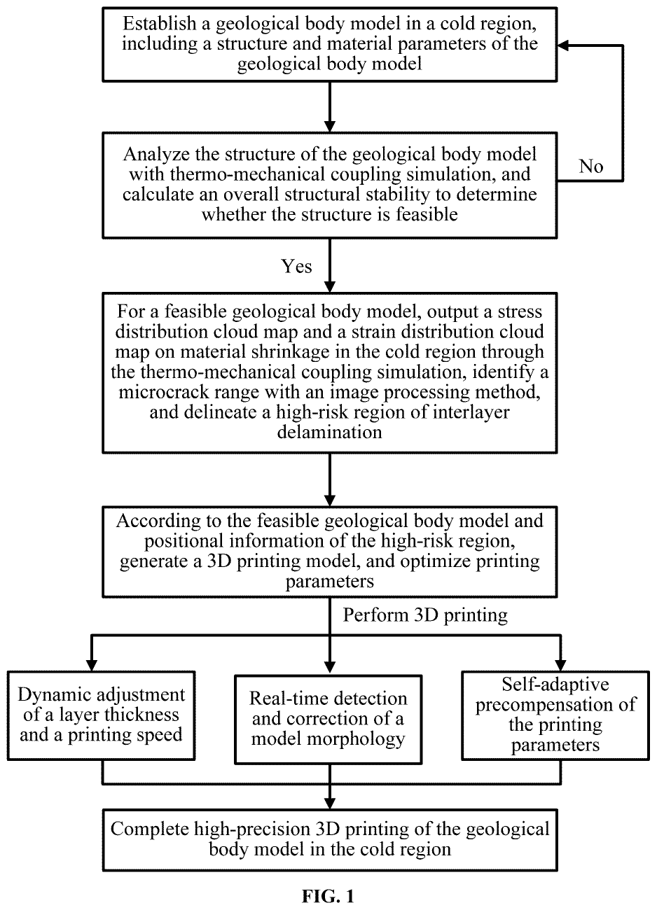

An embodiment provides a self-adaptive 3D printing method for a geological body model in a cold region. As shown in FIG. 1, it includes following steps:

S1: A geological body model in a cold region, including a geometric structure and material parameters of the geological body model, is constructed.

In this embodiment, the geological body model for the cold region is constructed with 3D modeling software. Model designs include the geometric structure and the material parameters.

Taking construction of a slope model of the cold region as an example, according to a height, an angle, a stratum condition, a support structure, and the like in the model designs, the 3D slope model is constructed with the 3D modeling software. The material parameters, i.e., mechanical strength parameters of a conventional 3D printing material (such as polylactic acid (PLA)), are input.

S2: Structural analysis is performed with multi-field coupling simulation, i.e., a structural stability of the geological body model is analyzed with thermo-mechanical coupling simulation, and whether the structural stability is feasible is determined.

In this embodiment, the geological body model for the cold region is input to numerical simulation software. A structural stability of the slope model is analyzed in a strength reduction method with the thermo-mechanical coupling simulation, and whether the structure is feasible is determined.

S3: While the structure is feasible, a stress distribution cloud map and a strain distribution cloud map on material shrinkage in the cold region are further output through the thermo-mechanical coupling simulation, a microcrack range is identified with an image processing method, and a high-risk region of interlayer delamination is delineated.

In this embodiment, while the structure of the slope model of the cold region is feasible, a stress distribution cloud map and a strain distribution cloud map on material shrinkage of the slope model of the cold region are further output through the thermo-mechanical coupling simulation, a microcrack range is identified with an image processing method such as segmentation or clustering, and a high-risk region of interlayer delamination is delineated to serve as a basis for subsequently optimizing printing parameters.

S4: A 3D printing model is generated and printing parameters are optimized, i.e., according to the geological body model that is feasible through structural stability analysis and positional information of the high-risk region, the printing model and the printing parameters are generated.

In this embodiment, the slope model that is feasible through structural analysis and positional information of the high-risk region are input to a 3D printing control program to generate a printing model. According to sensitivities of different portions of the printing material of the geological body model in the cold region to cracks, different layer thicknesses, different printing speeds, and other printing parameters are designed, enhancing the printing precision, and improving the printing effect. In the high-risk region of the interlayer delamination, a small layer thickness is set for a 3D printing device, and a printing speed is fine-adjusted and reduced, thereby providing an initial fine-adjustment value for dynamic adjustment of subsequent 3D printing parameters. For example, in this embodiment, the conventional 3D printing device has a layer thickness precision of 0.06 mm to 0.8 mm, and it is recommended to set a printing layer thickness to 0.06 mm to 0.1 mm.

S5: 3D printing is performed according to a generated 3D printing model and optimized printing parameters. During the 3D printing, dynamic adjustment of a layer thickness and a printing speed, real-time detection and correction of a model morphology, and self-adaptive precompensation of the printing parameters are performed simultaneously. The principle for dynamically adjusting the layer thickness is to decrease the layer thickness when the environment temperature or the nozzle temperature is less than the design temperature, and increase the layer thickness when the environment temperature or the nozzle temperature is greater than the design temperature.

In this embodiment, the dynamic adjustment of the layer thickness and the printing speed is implemented as follows: According to real-time feedback on the environment temperature in a model chamber during the 3D printing and on the nozzle temperature during the 3D printing, the layer thickness and the printing speed are dynamically adjusted, so as to prevent the interlayer delamination to ensure the printing precision. The layer thickness and the printing speed are decreased when the environment temperature or the nozzle temperature is less than the design temperature. The layer thickness and the printing speed are increased when the environment temperature or the nozzle temperature is greater than the design temperature.

In this embodiment, the real-time detection and correction of the model morphology are implemented as follows: A surface morphology is scanned with an online laser scanner whenever five layers have been printed, and is compared with a model design scheme in real time. If a local dimensional deviation exceeds a control precision, additional printing or trimming is performed, thereby realizing the real-time detection and correction of the model morphology.

In this embodiment, the self-adaptive precompensation of the printing parameters is implemented as follows: By fusing the temperature and model morphology error monitoring data, a printing error of a next layer is predicted and compensated in advance, thereby realizing the self-adaptive precompensation of the printing parameters. If the model morphology of this layer has a large error, the layer thickness and the printing speed of the next layer are decreased, improving the printing precision.

S6: By self-adaptively controlling the printing parameters, an effect of the generated 3D printing model is monitored in real time and the generated 3D printing model is corrected in real time, and high-precision 3D printing of the geological body model in the cold region is completed.

The above are merely preferred embodiments of the present disclosure, which do not impose any limitation on the present disclosure. Any form of equivalent replacement or modification and the like performed on the technical solutions and technical contents disclosed by the present disclosure by those skilled in the art without departing from the technical solutions of the present disclosure do not deviate from the technical solutions of the present disclosure and still fall within the protection scope of the present disclosure.

What is claimed is:

1. A self-adaptive three-dimensional (3D) printing method for a geological body model in a cold region, comprising following steps:
S1: establishing a geological body model in a cold region, comprising a structure and material parameters of the geological body model;
S2: analyzing the structure of the geological body model with thermo-mechanical coupling simulation, and calculating an overall structural stability to determine whether the structure is feasible;
S3: for a feasible geological body model, outputting a stress distribution cloud map and a strain distribution cloud map on material shrinkage in the cold region through the thermo-mechanical coupling simulation, identifying a microcrack range with an image processing method, and delineating a high-risk region of interlayer delamination;
S4: according to the feasible geological body model and positional information of the high-risk region, generating a 3D printing model, and optimizing printing parameters;
S5: performing 3D printing according to a generated 3D printing model and optimized printing parameters, wherein during the 3D printing, dynamic adjustment of a layer thickness and a printing speed, real-time detection and correction of a model morphology, and self-adaptive precompensation of the printing parameters are performed simultaneously; and
S6: by self-adaptively controlling the printing parameters, monitoring an effect of the generated 3D printing model in real time and correcting the generated 3D printing model in real time, and completing high-precision 3D printing of the geological body model in the cold region.

2. The self-adaptive 3D printing method for a geological body model in a cold region according to claim 1, wherein the printing parameters comprise the layer thickness, an infill density, the printing speed, and a temperature.

3. The self-adaptive 3D printing method for a geological body model in a cold region according to claim 1, wherein in the step S5, during the 3D printing, according to real-time feedback on an environment temperature in a model chamber during the 3D printing and on a nozzle temperature during the 3D printing, the layer thickness and the printing speed are dynamically adjusted; and a principle for dynamically adjusting the layer thickness is to decrease the layer thickness when the environment temperature or the nozzle temperature is less than a design temperature, and increase the layer thickness when the environment temperature or the nozzle temperature is greater than the design temperature.

4. The self-adaptive 3D printing method for a geological body model in a cold region according to claim 1, wherein in the step S5, during the 3D printing, a surface morphology is scanned with an online laser scanner, and is compared with a model design scheme in real time; and if a local dimensional deviation exceeds a control precision, additional printing or trimming is performed, thereby realizing the real-time detection and correction of the model morphology.

5. The self-adaptive 3D printing method for a geological body model in a cold region according to claim 1, wherein in the step S5, by fusing temperature and model morphology error monitoring data, a printing error of a next layer is predicted and compensated in advance, thereby realizing the self-adaptive precompensation of the printing parameters.
